(19) United States
(12) Patent Application Publication
(10) Pub. No.: US 2008/0277177 A1
(43) Pub. Date: Nov. 13, 2008

(54) Wiring System and Method for a Rearview Mirror

(75) Inventors: Steven E. Morris, Fair Haven, MI (US); Jennifer P. Lawall, Waterford, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/746,084

(22) Filed: May 9, 2007

(51) Int. Cl. B60K 35/00

(52) U.S. Cl. 180/65.8; 296/1.11; 296/190.1

(57) ABSTRACT

A wiring system and method are provided for an automobile having a windshield, a headliner, an auxiliary system, and a rearview mirror having a function and control mechanism associated with the auxiliary system. The wiring system includes a first interface coupled to the rearview mirror, and at least one conductor coupled to the first interface for coupling the auxiliary system to the function and control mechanism of the rearview mirror. A portion of the at least one conductor extends from the headliner to the first interface and at least half of the portion of the at least one conductor is bonded to the windshield.

### TECHNICAL FIELD

The present invention generally relates to a wiring system, and more particularly relates to a wiring system for a rearview mirror.

### BACKGROUND OF THE INVENTION

In modern automobiles, various auxiliary systems are accessible through the rearview mirror, particularly through function and control buttons provided with the rearview mirror. As an example, the function and control buttons for an OnStar® system can be provided with the rearview mirror. Wires are typically provided to the function and control buttons to provide power and/or connections to the auxiliary system associated with the function and control buttons. Generally, the wires extend from the headliner of the automobile directly to the rearview mirror. Typically, the wires are relatively thick and extend down from the headliner in the automobile to the mirror, and may be covered by a rectangular plastic cover. The visible wires, or the cover, can be unsightly and very noticeable above or in front of the mirror. The wires, or the cover, can also make cleaning the inside of the windshield relatively difficult.

Accordingly, it is desirable to provide a wiring system for power, function, and/or control buttons of an auxiliary system provided with the rearview mirror that provides an improved appearance and performance. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

A wiring system is provided for an automobile having a windshield, a headliner, an auxiliary system, and a rearview mirror having a function and control mechanism associated with the auxiliary system. The wiring system includes a first interface coupled to the rearview mirror, and at least one conductor coupled to the first interface for coupling the auxiliary system to the function and control mechanism of the rearview mirror. A portion of the at least one conductor extends from the headliner to the first interface and at least half of the portion of the at least one conductor is bonded to the windshield.

A method is provided for wiring a auxiliary system in an automobile having a windshield, a headliner, and a rearview mirror having a function and control mechanism associated with the auxiliary system. The method comprising coupling a first interface to the rearview mirror; coupling at least one conductor to the first interface for coupling the auxiliary system to the function and control mechanism of the rearview mirror, a portion of the least one conductor extending from the headliner to the first interface; and bonding at least half of the portion of the least one conductor to the windshield.

### DESCRIPTION OF THE DRAWINGS

The present invention will hereinafter be described in conjunction with the following drawing figures, wherein like numerals denote like elements, and

FIG. 1 is a front view of the wiring system in accordance with an exemplary embodiment of the present invention;

FIG. 2 is a side view of the wiring system of FIG. 1;

FIG. 3 is a front view of the wiring system of FIG. 1 at the rearview mirror; and

FIG. 4 is a partial cross-sectional view of the wiring system through line IV-IV of FIGS. 1 and 2.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description. As used herein, the terms “coupling,” “extending,” and “connecting,” each refer to a physical and/or an electrical connection, either directly or indirectly though other elements.

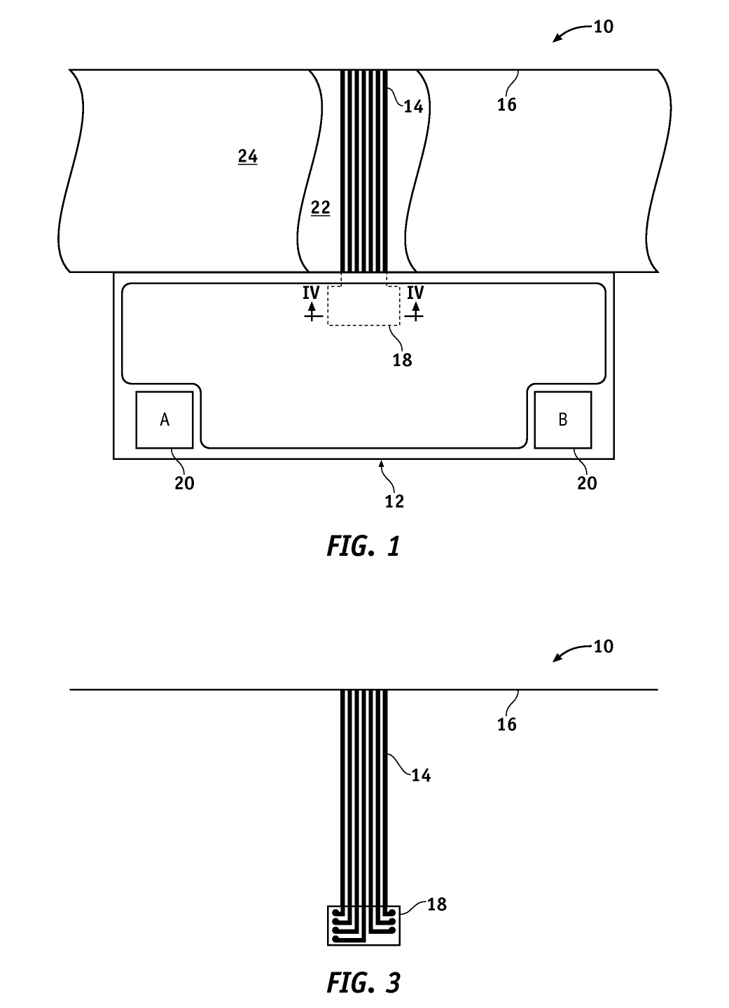

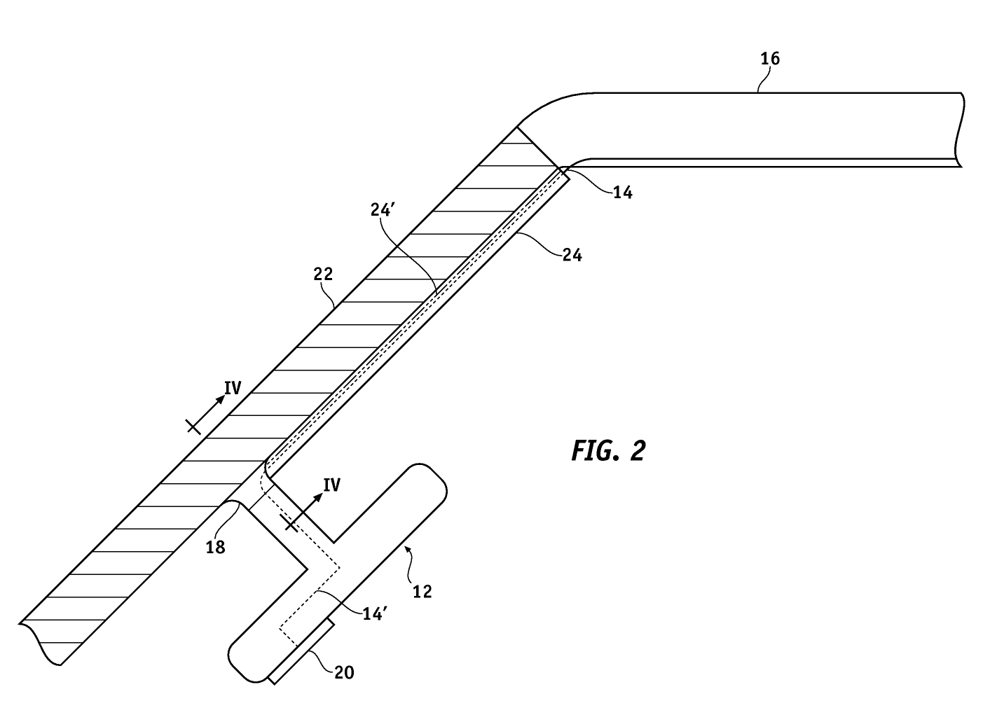

Referring particularly to FIGS. 1 and 2, a wiring system 10 for a rearview mirror 12 includes wires 14. A portion of the wires 14 extend from a headliner 16 to an interface with the rearview mirror 12. The interface can be a mirror mount 18 that mounts the rearview mirror 12 to a windshield 22 of an automobile. The wires 14 transmit signals and/or power to or from a function and control mechanism of the rearview mirror 12 that is associated with one or more auxiliary systems (not shown). As shown in FIGS. 1 and 2, the function and control mechanism can be functional and control buttons 20 provided with the rearview mirror 12. Particularly, the wires 14 can connect the function and control buttons 20 to the auxiliary systems. The auxiliary systems can include, for example, an OnStar® system. The OnStar® system is an in-vehicle safety, security, and cell phone system, which at the push of one or more function and control buttons 20, can provide a wireless connection to personal services, roadside and emergency assistance, directions, and cell phone service. Other types of auxiliary systems that can be controlled by the function and control buttons 20 include vehicle information systems, rain sensors, clock, heads up display cameras, and/or garage door openers. Although FIG. 1 shows two function and control buttons 20, any number of function and control buttons 20 can be provided.

The wires 14 are relatively thin, for example, 10-200 microns. Thicker or thinner wires 14 can also be provided. The wires 14 can be, for example, ribbon wires. In the illustrated embodiments, the size of the wires 14, particularly in proportion to the other illustrated elements, has been exaggerated for clarity. The wires 14 can be any type of electrical, optical, and/or acoustical conductor, and can be manufactured from any type of conductive material, for example, copper.

As noted above, a portion of the wires 14 extend from the headliner to the mirror mount 18. At least some of the portion of the wires extending from the headliner 16 to the mirror mount 18 is bonded to the windshield 22. In one embodiment, at least half of the portion of the wires 14 extending from the headliner 16 to the mirror mount 18 is bonded to the windshield 22. In another embodiment, at least 75% of the portion of the wires 14 extending from the headliner 16 to the mirror mount 18 is bonded to the windshield 22. In another embodiment, substantially all of the portion of the wires 14 extending from the headliner 16 to the mirror mount 18 is bonded to the windshield.

The portion of the wires 14 can be printed or otherwise bonded to the windshield 22. The portion of the wires 14 can be bonded to the windshield 22 with, for example, adhesive. The adhesive can be a black adhesive. The adhesive can include an acrylate, which may include a two part epoxy activated by heat curing. Any suitable adhesive that bonds coated or uncoated wires to the windshield 22 can be provided. Other mechanisms of bonding the portion of the wires 14 to the windshield 22 can also be provided, for example, electroplating, patterning and etching, or lamination techniques.

A cover 24, for example a sheet cover, can cover the wires 14 on the windshield 22. In FIG. 1, a portion of the cover 24 has been removed to show the wires 14. The cover 24 can be just wide enough to cover the wires 14, or the cover 24 can extend partially or completely across the width of the windshield 22. In an exemplary embodiment, the cover 24 extends from the top of the windshield 22 to the mirror mount 18, or the bottom of the sun visors (not shown). The cover 24 can be an opaque or blackout material that renders the wires 14 essentially invisible from the driver. An exemplary embodiment of the wiring system 10 results in the rearview mirror 12 appearing wireless. The cover 24 can be a non-conductive material, for example, plastic. Other materials that can make up the cover 24 can include standard window blackout & sunblocking materials, such as MYLAR and polyester films, ethylene propylene diene monomer (EPDM) rubber, fluorinated ethylene propylene (FEP), polypropylene, and/or polyethylene. A non-conductive cover 24 can prevent shorting of the wires 14 and can prevent heat from building up in the cover 24, as well as preventing electrostatic discharge (ESD) and electromagnetic interference (EMI).

In alternate embodiments and as illustrated by the dashed line 24′ in FIG. 2, an additional cover 24′ can be provided between the wires 14 and the windshield 22 to result in covers 24, 24′ on both sides of the wires 14. This embodiment renders the wires 14 relatively invisible from the perspectives of both the driver and a viewer outside of the automobile.

As noted above, the wires 14 can be bonded to the windshield 22. As used herein, the term “bonded” encompasses the wires 14 being attached or printed to the windshield 22 with adhesive. The term also encompasses the wires being attached to a material, such as the additional cover 24′, which is then attached to the windshield 22, or being attached to the windshield 22 as a result of the being pressed against the windshield 22 by the cover 24.

The wires 14 interface with the mirror mount 18 to provide an electrical, optical, and/or acoustical connection between the function and control buttons 20 and the auxiliary system. FIG. 3 illustrates a front view of the wiring system 10 with the rearview mirror 12 and cover 24 removed for clarity. As shown in FIG. 3, the mirror mount 18 has a face to interface with the rearview mirror 12.

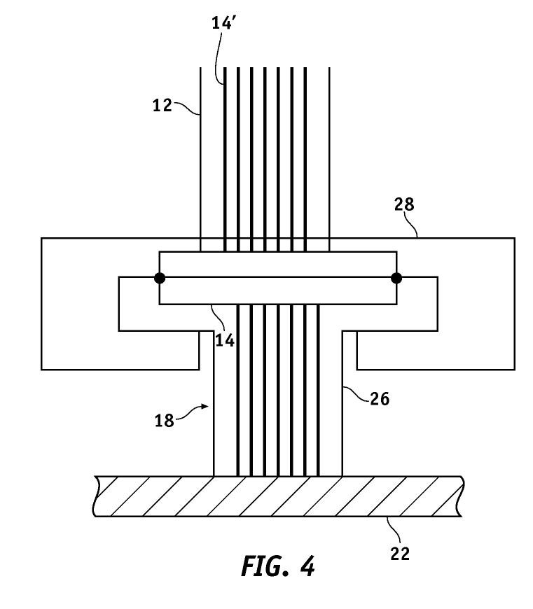

The mirror mount 18 can be a dock and lock connector to form a dock and lock connection with the rearview mirror 12. A dock and lock connection can provide a mechanical connection for mounting the mirror in which the electrical connections do not have to be separately aligned and connected. In other words, the dock and lock connection can include an electrical connection provided automatically in a single assembly step upon the mechanical connection in a single assembly. One example of the mirror mount 18 and rearview mirror 12 forming a dock and lock connection is shown in the cross-sectional view of FIG. 4. The mirror mount 18 can have a T-shaped portion 26 with the bottom portion of the T mounted to the windshield 22. The wires 14 extend to the top face of the mirror mount 18. The rearview mirror 12 can have a corresponding C-shaped portion 28 that mates with the T-shaped portion 26 of the mirror mount 18. Wires 14′ within the rearview mirror 12 corresponding to wires 14 in the mirror mount extend to the face of the C-shaped portion 28. When the C-shaped portion 28 mates with the T-shaped portion 26, wires 14 and wires 14′ are aligned and connected. A screw or additional attaching mechanism (not shown) can also be provided to secure the attachment. In one embodiment, the mirror mount 18 and rearview mirror 12 can be detachable relative to one another.

As a result of the wires 14 being bonded to the windshield and covered by the cover 24, an exemplary embodiment of the wiring system 10 is easier to clean than conventional systems because the wires 14 do not provide an obstruction. Moreover, the wiring system 10 provides a more rugged arrangement in that the wires 14 are less likely to be jostled and disconnected from the mirror mount 18. The wiring system 10 can be provided by an automobile manufacturer such that the auxiliary systems do not have to be separately wired by a dealer or customer.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A wiring system for an automobile having a windshield, a headliner, an auxiliary system, and a rearview mirror having a function and control mechanism associated with the auxiliary system, the wiring system, comprising:
a first interface coupled to the rearview mirror; and
at least one conductor coupled to the first interface for coupling the auxiliary system to the function and control mechanism of the rearview mirror,
wherein a portion of the at least one conductor extends from the headliner to the first interface and at least half of the portion of the at least one conductor is bonded to the windshield.

2. The wiring system of claim 1, wherein at least 75% of the portion of the at least one conductor is bonded to the windshield.

3. The wiring system of claim 1, wherein substantially all of the portion of the at least one conductor is bonded to the windshield.

4. The wiring system of claim 1, wherein the first interface is a mirror mount configured to mount the rearview mirror to the windshield.

5. The wiring system of claim 4, wherein the mirror mount is a dock and lock connector.

6. The wiring system of claim 1, wherein the function and control mechanism includes at least one button.

7. The wiring system of claim 1, wherein the at least one conductor is an electrical conductor.

8. The wiring system of claim 1, wherein the at least one conductor is an optical conductor.

9. The wiring system of claim 1, wherein the at least half of the portion of the at least one conductor is printed on the windshield.

10. The wiring system of claim 1, wherein the at least half of the portion of the at least one conductor has a thickness of 10-200 microns.

11. The wiring system of claim 1, wherein the at least half of the portion of the at least one conductor is bonded to the windshield with black adhesive.

12. The wiring system of claim 1, further comprising a cover for covering the at least half of the portion of the at least one conductor.

13. The wiring system of claim 12, wherein the cover is a blackout sheet cover.

14. The wiring system of claim 12, wherein the cover is a first cover, and the system further comprises a second cover,
wherein the second cover attaches to the windshield, the at least half of the portion of the at least one conductor attaches to the second cover, and the first cover attaches to the second cover and the at least half of the portion of the at least one conductor.

15. The wiring system of claim 12, wherein the cover is a non-conductive material.

16. A method for wiring an auxiliary system in an automobile having a windshield, a headliner, and a rearview mirror having a function and control mechanism associated with the auxiliary system, the method comprising:
coupling a first interface to the rearview mirror;
coupling at least one conductor to the first interface for coupling the auxiliary system to the function and control mechanism of the rearview mirror, a portion of the least one conductor extending from the headliner to the first interface; and
bonding at least half of the portion of the least one conductor to the windshield.

17. The method of claim 16, further comprising covering the at least half of the portion of the least one conductor with a cover.

18. The method of claim 16, wherein the bonding step includes bonding at least 75% of the portion of at least one conductor to the windshield.

19. The method of claim 16, wherein the bonding step includes bonding substantially all of the portion of at least one conductor to the windshield.

20. The method of claim 16, wherein the bonding step includes printing the portion of at least one conductor on the windshield.
